(19) United States
(12) Patent Application Publication
(10) Pub. No.: US 2015/0037668 A1
(43) Pub. Date: Feb. 5, 2015

(54) NON-AQUEOUS ELECTROLYTE SOLUTION FOR SECONDARY BATTERIES, AND LITHIUM ION SECONDARY BATTERY

(71) Applicant: Asahi Glass Company, Limited, Chiyoda-ku (JP)

(72) Inventors: Masao Iwaya, Chiyoda-ku (JP); Yu Onozaki, Chiyoda-ku (JP)

(73) Assignee: Asahi Glass Company, Limited, Chiyoda-ku (JP)

(21) Appl. No.: 14/507,132

(22) Filed: Oct. 6, 2014

Related U.S. Application Data
(63) Continuation of application No. PCT/JP2013/065725, filed on Jun. 6, 2013.

(30) Foreign Application Priority Data
Jun. 6, 2012 (JP) 2012-128985

(51) Int. Cl. H01M 10/0569; H01M 10/0525

(52) U.S. Cl. CPC H01M 10/0569; H01M 10/0525; H01M 2300/004; H01M 2300/0042; H01M 2300/0034
USPC 429/200

(57) ABSTRACT

The object is to provide a non-aqueous electrolyte solution for secondary batteries, which has sufficient ion conductivity and which is provided also with excellent high voltage cycle properties and high voltage high temperature preserving properties, and a lithium ion secondary battery employing such a non-aqueous electrolyte solution.

A non-aqueous electrolyte solution for secondary batteries, comprising a lithium salt and a liquid composition, wherein the liquid composition comprises from 5 to 50 vol % of a specific fluorinated ether compound, from 5 to 70 vol % of a specific fluorinated cyclic carbonate compound, and from 1 to 35 vol % of a specific sultone compound, and a lithium ion secondary battery employing such a non-aqueous electrolyte solution.

### TECHNICAL FIELD

The present invention relates to a non-aqueous electrolyte solution for secondary batteries, and a lithium ion secondary battery.

### BACKGROUND ART

For a non-aqueous electrolyte solution to be used for lithium ion secondary batteries (hereinafter sometimes referred to simply as “secondary batteries”), a carbonate type solvent such as ethylene carbonate or dimethyl carbonate, has been widely used in that it usually dissolves a lithium salt excellently to provide a high ion conductivity, and it has a wide potential window. However, a carbonate type solvent is flammable and is likely to catch fire by e.g. heat generation of the batteries.

Therefore, in order to increase non-flammability (flame retardancy) of the non-aqueous electrolyte, it has been proposed to use a fluorinated solvent. Further, in order to increase cycle properties, it has also been proposed to use a fluorinated cyclic carbonate compound. Specifically, a non-aqueous electrolyte solution containing a fluorinated cyclic carbonate compound and a fluorinated ether compound (Patent Document 1), or a non-aqueous electrolyte solution containing a fluorinated cyclic carbonate compound, a fluorinated ether compound and a carbonate type solvent having no fluorine atom (Patent Document 2), has, for example, been known.

On the other hand, in recent years, it has been actively studied to apply secondary batteries to e.g. power sources for vehicles such as electric automobiles which require larger energies, and a non-aqueous electrolyte solution which can be used at a high voltage of at least 4.5 V is desired.

As a non-aqueous electrolyte solution having improved preserving properties at a high voltage, a non-aqueous electrolyte solution containing a sultone compound and a carbonate type solvent having no fluorine atom, is known (Patent Documents 3 and 4).

### PRIOR ART DOCUMENTS

### Patent Documents

Patent Document 1: WO 2008/096729

Patent Document 2: WO 2009/035085

Patent Document 3: JP-A-2011-86632

Patent Document 4: JP-A-2011-96672

### DISCLOSURE OF INVENTION

### Technical Problems

However, with non-aqueous electrolyte solutions as disclosed in Patent Documents 1 and 2, it is difficult to obtain adequate preserving properties in a high voltage and high temperature environment. Further, with non-aqueous electrolyte solutions as disclosed in Patent Documents 3 and 4, it is difficult to obtain adequate cycle properties in charge and discharge at a high voltage.

It is an object of the present invention to provide a non-aqueous electrolyte solution for secondary batteries, which has sufficient ion conductivity and which is provided also with excellent high voltage cycle properties and high voltage high temperature preserving properties, and a lithium ion secondary battery employing such a non-aqueous electrolyte solution for secondary batteries.

### Solution to Problems

The present invention has adopted the following constructions in order to solve the above problems.

[1] A non-aqueous electrolyte solution for secondary batteries, comprising a lithium salt and a liquid composition, wherein

the liquid composition comprises from 5 to 50 vol % of at least one fluorinated ether compound selected from the group consisting of a compound represented by the following formula (1) and a compound represented by the following formula (2), from 5 to 70 vol % of a fluorinated cyclic carbonate compound represented by the following formula (3), and from 1 to 35 vol % of a sultone compound represented by the following formula (4):

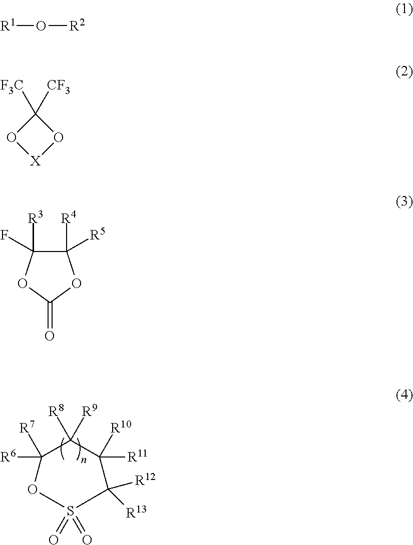

wherein each of R¹ and R² which are independent of each other, is a C₁₋₁₀ alkyl group, a C₃₋₁₀ cycloalkyl group, a C₁₋₁₀ fluorinated alkyl group, a C₃₋₁₀ fluorinated cycloalkyl group, a C₂₋₁₀ alkyl group having an etheric oxygen atom, or a C₂₋₁₀ fluorinated alkyl group having an etheric oxygen atom, provided that one or each of R¹ and R² is a C₁₋₁₀ fluorinated alkyl group, a C₃₋₁₀ fluorinated cycloalkyl group, or a C₂₋₁₀ fluorinated alkyl group having an etheric oxygen atom;

X is a C₁₋₅ alkylene group, a C₁₋₅ fluorinated alkylene group, a C₂₋₅ alkylene group having an etheric oxygen atom, or a C₂₋₅ fluorinated alkylene group having an etheric oxygen atom;

each of R³ to R⁵ which are independent of one another, is a C₁₋₄ alkyl group, a fluorine atom, or a hydrogen atom;

each of R⁶ to R¹³ which are independent of one another, is a hydrogen atom, a fluorine atom, or a methyl group; and

n is 0 or 1.

[2] The non-aqueous electrolyte solution for secondary batteries according to the above [1], wherein the fluorinated cyclic carbonate compound is a compound represented by the formula (3) wherein each of R³ and R⁵ is a hydrogen atom, and R⁴ is a hydrogen atom or a fluorine atom.
[3] The non-aqueous electrolyte solution for secondary batteries according to the above [1] or [2], wherein the sultone compound is a compound represented by the formula (4) wherein each of R⁶ to R¹² is a hydrogen atom, and R¹³ is a hydrogen atom or a methyl group.
[4] The non-aqueous electrolyte solution for secondary batteries according to any one of the above [1] to [3], wherein the fluorinated ether compound is a compound represented by the formula (1), and said compound is at least one member selected from the group consisting of CF₃CH₂OCF₂CHF₂, CF₃CH₂OCF₂CHFCF₃, CHF₂CF₂CH₂OCF₂CHF₂, CH₃CH₂CH₂CH₂OCF₂CHF₂, CH₃CH₂CH₂OCF₂CHF₂, CH₃CH₂OCF₂CHF₂ and CHF₂CF₂CH₂OCF₂CHFCF₃.
[5] The non-aqueous electrolyte solution for secondary batteries according to any one of the above [1] to [4], wherein the liquid composition further contains at least one member selected from the group consisting of a cyclic carbonate compound having no fluorine atom, a chain carbonate compound, a saturated cyclic sulfone compound and a phosphoric acid ester compound.
[6] The non-aqueous electrolyte solution for secondary batteries according to any one of the above [1] to [5], wherein the ion conductivity at 25° C. of the non-aqueous electrolyte solution is at least 0.4 S/m.
[7] The non-aqueous electrolyte solution for secondary batteries according to any one of the above [1] to [6], wherein the lithium salt contains LiPF₆.
[8] The non-aqueous electrolyte solution for secondary batteries according to any one of the above [1] to [7], wherein the content of the lithium salt in the non-aqueous electrolyte solution is from 0.1 to 3.0 mol/L.
[9] A lithium ion secondary battery comprising a positive electrode containing, as an active material, a material capable of absorbing and desorbing lithium ions, a negative electrode containing, as an active material, at least one member selected from the group consisting of metal lithium, an lithium alloy and a carbon material capable of absorbing and desorbing lithium ions, and the non-aqueous electrolyte solution for secondary batteries as defined in any one of the above [1] to [8].

### Advantageous Effects of Invention

The non-aqueous electrolyte solution for secondary batteries of the present invention has sufficient ion conductivity and is provided also with excellent high voltage cycle properties and high voltage high temperature preserving properties.

The lithium ion secondary battery of the present invention has sufficient ion conductivity and is provided also with excellent high voltage cycle properties and high voltage high temperature preserving properties, and it can be used at a high voltage.

### DESCRIPTION OF EMBODIMENTS

In this specification, a compound represented by the formula (1) will be referred to as a compound (1), unless otherwise specified, and the same applies to compounds represented by other formulae.

In this specification, “fluorinated” means that some or all of hydrogen atoms bonded to carbon atoms are substituted by fluorine atoms. A “fluorinated alkyl group” is a group having some or all of hydrogen atoms in an alkyl group substituted by fluorine atoms. In a partly fluorinated group, hydrogen atoms and fluorine atoms are present. Further, a “perfluoroalkyl group” is a group having all of hydrogen atoms in an alkyl group substituted by fluorine atoms. Further, a “carbon-carbon unsaturated bond” is a carbon-carbon double bond or a carbon-carbon triple bond.

### <Non-Aqueous Electrolyte Solution for Secondary Batteries>

The non-aqueous electrolyte solution for secondary batteries of the present invention (hereinafter sometimes referred to simply as “the non-aqueous electrolyte solution”) comprises a lithium salt and a liquid composition. The liquid composition comprises a fluorinated ether compound, a fluorinated cyclic carbonate compound and a sultone compound, which will be described later.

A non-aqueous electrolyte solution is an electrolyte solution containing substantially no water, and even if it contains water, the amount of water is within such a range that performance degradation of a secondary battery using the non-aqueous electrolyte solution is thereby not observed. The amount of water contained in such a non-aqueous electrolyte solution is preferably at most 500 mass ppm, more preferably at most 100 mass ppm, particularly preferably at most 50 mass ppm, based on the total mass of the non-aqueous electrolyte solution. The lower limit of the amount of water is 0 mass ppm.

### [Lithium Salt]

The lithium salt is an electrolyte which will be dissociated in the non-aqueous electrolyte solution to supply lithium ions. As such a lithium salt, preferred is at least one member selected from the group consisting of LiPF₆, the following compound (A) (wherein k is an integer of from 1 to 5), FSO₂N(Li)SO₂F, CFSSO₂N(Li)SO₂CF₃, CF₃CF₂SO₂N(Li) SO₂CF₂CF₃, LiCIO₄, the following compound (B), the following compound (C), the following compound (D), the following compound (E) and LiBF₄. As the lithium salt, more preferred is at least one member selected from the group consisting of LiPF₆, LiBF₄ and the compound (A).

The lithium salt to be contained in the non-aqueous electrolyte solution of the present invention may be one type only, or two or more types in combination. As the combination in a case where two or more lithium salts are used in combination, those combinations as disclosed in WO 2009/133899 may be mentioned.

The lithium salt preferably contains LiPF₆. The lower limit in the molar ratio of LiPF₆ to the total number of moles of the lithium salt contained in the non-aqueous electrolyte solution of the present invention, is preferably 40 mol %, more preferably 50 mol %, further preferably 65 mol %, particularly preferably 80 mol %. The upper limit in the molar ratio of LiPF₆ to the total number of moles of the lithium salt contained in the non-aqueous electrolyte solution, is 100 mol %. When the molar ratio of LiPF₆ to the total number of moles of the lithium salt is at least the lower limit value, such a non-aqueous electrolyte solution will be excellent in ion conductivity and will be highly practically useful.

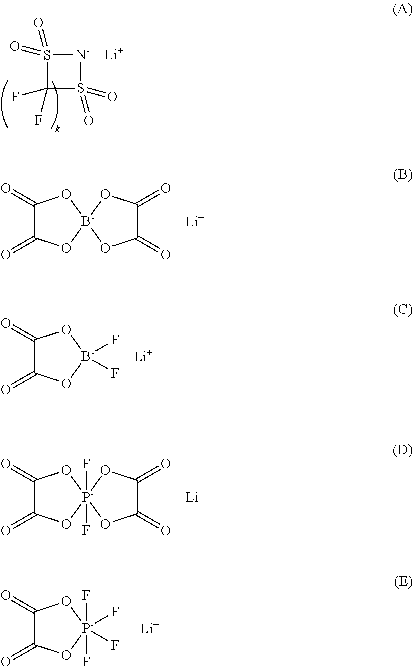

As the compound (A), the following compounds (A-1) to (A-4) may, for example, be mentioned. From such a viewpoint that a non-aqueous electrolyte solution having high ion conductivity is readily obtainable, the compound (A) preferably contains the compound (A-2) wherein k is 2, and it is more preferably composed solely of the compound (A-2) wherein k is 2.

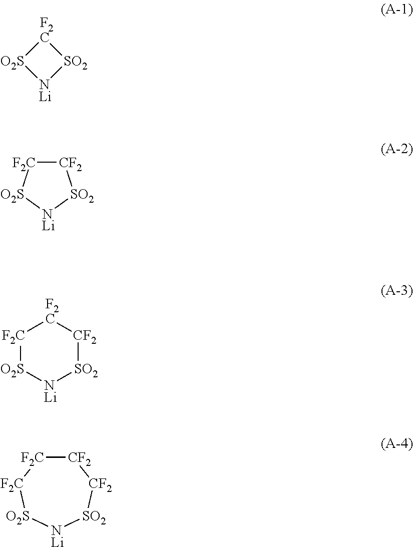

The content of the lithium salt in the non-aqueous electrolyte solution is not particularly limited, but is preferably from 0.1 to 3.0 mol/L. The lower limit for the content of the lithium salt is more preferably 0.5 mol/L, further preferably 0.8 mol/L. Further, the upper limit for the content of the lithium salt is more preferably 1.8 mol/L, further preferably 1.6 mol/L.

In terms of mass %, the content of the lithium salt in the non-aqueous electrolyte solution, is preferably from 5 mass % to 25 mass %. The lower limit value for the content of the lithium salt is more preferably 7 mass %, further preferably 8 mass %. Further, the upper limit value for the content of the lithium salt is more preferably 20 mass %, further preferably 17 mass %.

When the content of the lithium salt is at least the above lower limit value, the ion conductivity of the non-aqueous electrolyte solution is high. Further, when the content of the lithium salt is at most the above upper limit value, the lithium salt is readily uniformly soluble in the liquid composition, and the lithium salt will not precipitate even under a low temperature condition.

### [Fluorinated Ether Compound]

The liquid composition in the non-aqueous electrolyte solution of the present invention contains at least one fluorinated ether compound selected from the group consisting of the following compound (1) and the following compound (2). The fluorinated ether compound is excellent in high voltage durability and non-flammability (flame retardancy). Further, the fluorinated ether compound has a low interface tension and thus is excellent also in wettability to an electrode and a separator. The fluorinated ether compound contained in the liquid composition may be one type only, or two or more types in combination. In a case where the fluorinated ether compound contained in the liquid composition is two or more types, their mutual ratio may be optionally determined.

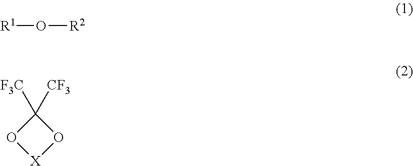

Here, in the formula (1), each of R¹ and R² which are independent of each other, is a C₁₋₁₀ alkyl group, a C₃₋₁₀ cycloalkyl group, a C₁₋₁₀ fluorinated alkyl group or a C₃₋₁₀ fluorinated cycloalkyl group, a C₂₋₁₀ alkyl group having an etheric oxygen atom, or a C₂₋₁₀ fluorinated alkyl group having an etheric oxygen atom, and either one or each of R¹ and R² is a C₁₋₁₀ fluorinated alkyl group, a C₃₋₁₀ fluorinated cycloalkyl group, or a C₂₋₁₀ fluorinated alkyl group having an etheric oxygen atom.

Further, in the formula (2), X is a C₁₋₅ alkylene group, a C₁₋₅ fluorinated alkylene group, a C₂₋₅ alkylene group having an etheric oxygen atom, or a C₂₋₅ fluorinated alkylene group having an etheric oxygen atom.

Each of the alkyl group and the alkyl group having an etheric oxygen atom may be a group having a straight chain structure, a branched structure or a partially cyclic structure (e.g. a cycloalkylalkyl group).

Either one or each of R¹ and R² in the compound (1) is a C₁₋₁₀ fluorinated alkyl group, a C₃₋₁₀ fluorinated cycloalkyl group, or a C₂₋₁₀ fluorinated alkyl group having an etheric oxygen atom. When either one or each of R¹ and R² is such a group, the non-aqueous electrolyte solution will be excellent in high voltage durability and non-flammability (flame retardancy). R¹ and R² in the compound (1) may be the same or different.

As the compound (1), a compound (1-A) wherein each of R¹ and R² is a C₁₋₁₀ fluorinated alkyl group, a compound (1-B) wherein R¹ is a C₂₋₁₀ fluorinated alkyl group having an etheric oxygen atom and R² is a C₁₋₁₀ fluorinated alkyl group, or a compound (1-C) wherein R¹ is a C₁₋₁₀ fluorinated alkyl group and R² is a C₁₋₁₀ alkyl group, is preferred; the compound (1-A) or the compound (1-C) is more preferred; and the compound (1-A) is particularly preferred.

The total number of carbon atoms in the compound (1) is preferably from 4 to 10, more preferably from 4 to 8, since if it is too small, the boiling point tends to be too low, and if it is too large, the viscosity tends to be high. The molecular weight of the compound (1) is preferably from 150 to 800, more preferably 150 to 500, particularly preferably from 200 to 500. The number of etheric oxygen atoms in the compound (1) is influential to flammability. Therefore, the number of etheric oxygen atoms in the compound (1) having an etheric oxygen atom is preferably from 1 to 4, more preferably 1 or 2, further preferably 1. Further, when the fluorine content in the compound (1) (the fluorine content being the proportion of the total mass of fluorine atoms in the molecular weight) is high, the non-flammability (flame retardancy) will be excellent. The fluorine content in the compound (1) is preferably at least 50 mass %, more preferably at least 55 mass %, particularly preferably at least 60 mass %.

The compound (1) is preferably a compound wherein each of R¹ and R² is an alkyl group having some of its hydrogen atoms fluorinated, since the solubility of the lithium salt in the liquid composition is thereby excellent.

Particularly, the compound (1) is preferably a compound wherein the terminal structure of either one or each of R¹ and R² is —CF₂H, in that it is thereby excellent in high voltage durability and non-flammability (flame retardancy), and the solubility of the lithium salt in the liquid composition is thereby excellent.

Specific examples of the compound (1-A), the compound (1-B) and the fluorinated ether compounds other than the compound (1-A) and the compound (1-B) may, for example, be compounds disclosed in WO 2009/133899.

The compound (1) is preferably the compound (1-A), more preferably a compound selected from the group consisting of CF₃CH₂OCF₂CHF₂ (trade name: AE-3000, manufactured by Asahi Glass Company Limited), CF₃CH₂OCF₂CHFCF₃, CHF₂CF₂CH₂OCF₂CHF₂, CH₃CH₂CH₂CH₂OCF₂CHF₂, CH₃CH₂CH₂OCF₂CHF₂, CH₃CH₂OCF₂CHF₂ and CHF₂CF₂CH₂OCF₂CHFCF₃, particularly preferably at least one member selected from CF₃CH₂OCF₂CHF₂, CHF₂CF₂CH₂OCF₂CHF₂ and CHF₂CF₂CH₂OCF₂CHFCF₃.

In the compound (2), X may have a straight chain structure or a branched structure. X is preferably a C₁₋₅ alkylene group, more preferably a C₂₋₄ alkylene group. Such an alkylene group preferably has a straight chain structure or a branched structure. In a case where the alkylene group for X has a branched structure, the side chain is preferably a C₁₋₃ alkyl group, or a C₁₋₃ alkyl group having an etheric oxygen atom.

The compound (2) is preferably a compound of the formula (2) wherein X is one member selected from the group consisting of —CH₂—, —CH₂CH₂—, —CH(CH₃)CH₂— and —CH₂CH₂CH₂—, more preferably at least one of a compound wherein X is —CH₂CH₂—, and a compound wherein X is —CH(CH₃)CH₂—, and further preferably either one of a compound wherein X is —CH₂CH₂—, and a compound wherein X is —CH(CH₃)CH₂—.

Specific examples of the compound (2) may, for example, be compounds represented by the following formulae.

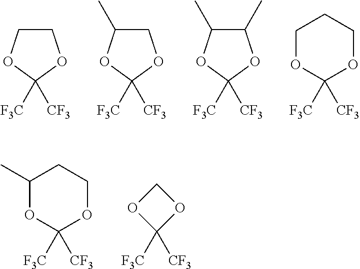

When the compound (1) and the compound (2) are above described compounds, the non-aqueous electrolyte solution tends to uniformly dissolve the lithium salt, and tends to be excellent in non-flammability (flame retardancy) and to have high ion conductivity.

The fluorinated ether compound is preferably the compound (1), the compound (2), or a mixture of the compound (1) and the compound (2), more preferably the compound (1) alone, or the compound (2) alone.

In a case where the non-aqueous electrolyte solution of the present invention contains the compound (1), the compound (1) may be one type alone, or two or more types in combination. Further, in a case where the non-aqueous electrolyte solution of the present invention contains the compound (2), the compound (2) may be one type alone, or two or more types in combination.

In a case where the compound (1) (mass: Va) and the compound (2) (mass: Vb) are used in combination as the fluorinated ether compound, their mass ratio (VbNa) is preferably from 0.01 to 100, more preferably from 0.1 to 10.

The content of the fluorinated ether compound in the liquid composition of the present invention is from 5 to 50 vol %. The lower limit value for the content of the fluorinated ether compound is preferably 5 vol %, more preferably 10 vol %, further preferably 15 vol %. Further, the upper limit value for the content of the fluorinated ether compound is preferably 50 vol %, more preferably 45 vol %, further preferably 40 vol %.

When the content of the fluorinated ether compound is at least the lower limit value, the non-aqueous electrolyte solution will be excellent in non-flammability (flame retardancy), will have low positive electrode reactivity and low negative electrode reactivity, will be less susceptible to thermal runaway, will have a high level of high voltage durability and will have excellent wettability to an electrode and a separator. When the content of the fluorinated ether compound is at most the upper limit value, the lithium salt will readily be uniformly dissolved, and the lithium salt tends to be scarcely precipitated at a low temperature, whereby ion conductivity tends to be scarcely lowered.

The content of the fluorinated ether compound in the liquid composition is preferably from 5 to 50 vol %, more preferably from 10 to 45 vol %, further preferably from 15 to 40 vol %.

### [Fluorinated Cyclic Carbonate Compound]

The liquid composition in the non-aqueous electrolyte solution of the present invention contains the following compound (3) which is a fluorinated cyclic carbonate compound. As it contains the compound (3), the non-aqueous electrolyte solution is excellent in high voltage cycle properties. The compound (3) may be one type only, or two or more types in combination.

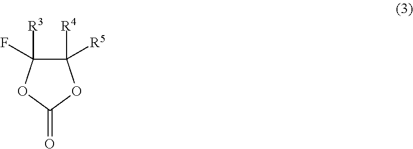

In the formula (3), each of R³ to R⁵ which are independent of one another, is a C₁₋₄ alkyl group, a fluorine atom or a hydrogen atom.

R³ to R⁵ in the compound (3) may be the same or different.

Each of R³ to R⁵ is preferably a hydrogen atom or a fluorine atom, and it is more preferred that R³ and R⁵ are hydrogen atoms and R⁴ is a hydrogen atom or a fluorine atom.

The compound (3) may, for example, be the following compounds (3-1) to (3-3), and the following compound (3-1) or (3-2) is preferred, since it is excellent in high voltage cycle properties.

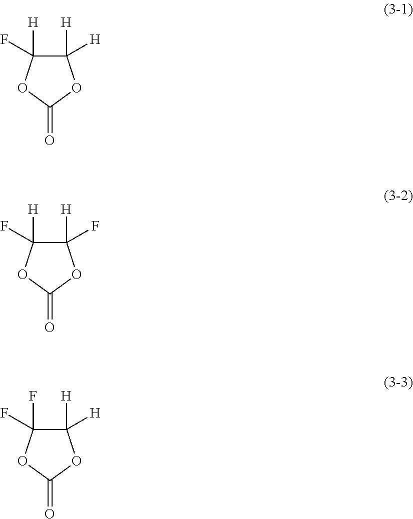 [SMILES: O=C1OCC(F)O1 ; O=C1OC(F)C(F)O1 ; O=C1OCC(F)(F)O1]

The content of the compound (3) in the liquid composition of the present invention is from 5 to 70 vol %. The lower limit value for the content of the compound (3) is preferably 5 vol %, more preferably 10 vol %, further preferably 15 vol %. The upper limit value for the content of the compound (3) is preferably 70 vol %, more preferably 65 vol %, further preferably 60 vol %.

When the content of the compound (3) is at least the lower limit value, the non-aqueous electrolyte solution will be excellent in high voltage cycle properties. Further, when the content of the compound (3) is at most the upper limit value, the non-aqueous electrolyte solution will be excellent in non-flammability (flame retardancy) and voltage durability, and the reactivity of the non-aqueous electrolyte solution with a positive electrode and a negative electrode will be low, whereby thermal runaway tends to be less likely to occur.

The content of the compound (3) in the liquid composition of the present invention is preferably from 10 to 65 vol %, more preferably from 15 to 60 vol %.

### [Sultone Compound]

The liquid composition in the non-aqueous electrolyte solution of the present invention contains the following compound (4) which is a sultone compound. As it contains the compound (4), the non-aqueous electrolyte solution is excellent in high voltage high temperature preserving properties. The compound (4) may be one type only, or two or more types in combination.

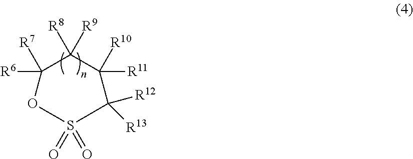

In the formula (4), each of R⁶ to R¹³ which are independent of one another, is a hydrogen atom, a fluorine atom or a methyl group. n is 0 or 1.

R⁶ to R¹³ in the compound (4) may be the same or different.

Each of R⁶ to R¹³ is preferably a hydrogen atom or a methyl group, and it is more preferred that R⁶ to R¹² are hydrogen atoms and R¹³ is a hydrogen atom or a methyl group.

n is preferably 0 or 1, more preferably 0.

The compound (4) may, for example, be 1,3-propane sultone, 1,4-butane sultone or 2,4-butane sultone. Among them, 1,3-propane sultone or 2,4-butane sultone is preferred, since it is excellent in high voltage high temperature preserving properties.

The content of the compound (4) in the liquid composition of the present invention is from 1 to 35 vol %. The lower limit value for the content of the compound (4) is preferably 1 vol %, more preferably 2 vol %, further preferably 5 vol %. The upper limit value for the content of the compound (4) is preferably 35 vol %, more preferably 32 vol %, further preferably 30 vol %.

When the content of the compound (4) is at least the lower limit value, the non-aqueous electrolyte solution will be excellent in high voltage high temperature preserving properties. Further, when the content of the compound (4) is at most the upper limit value, it is possible to suppress the viscosity of the non-aqueous electrolyte solution to be low, whereby high conductivity can easily be maintained.

The content of the compound (4) in the liquid composition of the present invention is preferably from 1 to 35 vol %, more preferably from 2 to 32 vol %, particularly preferably from 5 to 30 vol %.

### [Other Solvent]

The liquid composition in the non-aqueous electrolyte solution of the present invention may contain a solvent other than the above fluorinated ether compound, fluorinated cyclic carbonate compound and sultone compound. Such other solvent is preferably at least one member (which may generally be referred to as a “compound (α)) selected from the group consisting of a cyclic carbonate compound having no fluorine atom (hereinafter referred to as a “non-fluorinated cyclic carbonate compound”), a chain carbonate compound, a saturated cyclic sulfone compound and a phosphoric acid ester compound, since the non-aqueous electrolyte solution will be thereby excellent in the solubility of the lithium salt and the ion conductivity.

The non-fluorinated cyclic carbonate compound is a compound having a ring structure wherein the ring skeleton is constituted by carbon atoms and oxygen atoms and is a compound wherein the ring structure has a carbonate bond represented by —O—C(═O)—O—. For example, propylene carbonate (PC), ethylene carbonate (EC), vinylene carbonate (VC), vinyl ethylene carbonate (VEC) or butylene carbonate (BC) may be mentioned.

The chain carbonate compound is a chain compound which has no ring structure and has a carbonate bond represented by —O—C(═O)—O—. For example, dimethyl carbonate (DMC), ethylmethyl carbonate (EMC), diethyl carbonate (DEC), bis(2,2,2-trifluoroethyl) carbonate or bis(2,2,3,3-tetrafluoropropyl) carbonate may be mentioned.

The saturated cyclic sulfone compound may, for example, be sulfolane or 3-methylsulfolane.

The phosphoric acid ester compound may, for example, be a trimethyl phosphate or triethyl phosphate.

The non-aqueous electrolyte solution of the present invention may not contain such other solvent. In a case where it contains other solvent, the content of such other solvent in the non-aqueous electrolyte solution is preferably from 0.01 to 30 vol %, more preferably from 0.1 to 20 vol %. When the content of such other solvent is at most the upper limit value, the non-aqueous electrolyte solution will be excellent in high voltage cycle properties and high voltage high temperature preserving properties. Further, the content of the fluorinated ether compound can thereby be easily made large, whereby it is readily possible to obtain a non-aqueous electrolyte solution excellent in non-flammability.

In a case where the non-aqueous electrolyte solution of the present invention contains the compound (a), the content of the compound (a) in the non-aqueous electrolyte solution is preferably from 0.01 to 30 vol %, more preferably from 0.1 to 20 vol %.

The non-aqueous electrolyte solution of the present invention may not contain the non-fluorinated cyclic carbonate compound.

The content of the non-fluorinated cyclic carbonate compound in the non-aqueous electrolyte solution is preferably at most 20 vol %, more preferably at most 15 vol %, further preferably less than 10 vol %, particularly preferably at most 5 vol %, most preferably at most 3 vol %.

In a case where the non-aqueous electrolyte solution of the present invention contains the non-fluorinated cyclic carbonate compound, the content of the non-fluorinated cyclic carbonate compound in the non-aqueous electrolyte solution, is preferably from 0.01 to 20 vol %, more preferably from 0.01 to 15 vol, further preferably at least 0.01 vol % and less than 10 vol %, particularly preferably from 0.01 to 5 vol %, most preferably from 0.01 to 3 vol %. When the content of the non-fluorinated cyclic carbonate compound is at most the upper limit value, the non-aqueous electrolyte solution will be excellent in high voltage cycle properties and high voltage high temperature preserving properties and will be excellent in non-flammability (flame retardancy).

The non-aqueous electrolyte solution of the present invention may not contain the chain carbonate compound.

The content of the chain carbonate compound in the non-aqueous electrolyte solution of the present invention is preferably at most 30 vol %, more preferably at most 25 vol %, further preferably less than 15 vol %.

In a case where the non-aqueous electrolyte solution of the present invention contains the chain carbonate compound, the content of the chain carbonate compound in the non-aqueous electrolyte solution is preferably from 0.01 to 30 vol %, more preferably from 0.01 to 25 vol %, further preferably at least 0.01 vol % and less than 20%, particularly preferably from 0.01 to 15 mass %, for the same reason as in the case of the non-fluorinated cyclic carbonate compound.

The non-aqueous electrolyte solution of the present invention may not contain the saturated cyclic sulfone compound.

The content of the saturated cyclic sulfone compound in the non-aqueous electrolyte solution of the present invention is preferably at most 20 vol %, more preferably at most 15 vol %, particularly preferably at most 10 vol %, most preferably at most 5 vol %.

In a case where the non-aqueous electrolyte solution of the present invention contains the saturated cyclic sulfone compound, the content of the saturated cyclic sulfone compound in the non-aqueous electrolyte solution is preferably from 0.01 to 20 vol %, more preferably from 0.01 to 15 vol %, further preferably from 0.01 to 10 vol %, particularly preferably from 0.01 to 5 vol %, for the same reason as in the case of the non-fluorinated cyclic carbonate compound.

The non-aqueous electrolyte solution of the present invention may not contain the phosphoric acid ester compound.

The content of the phosphoric acid ester compound in the non-aqueous electrolyte solution of the present invention is preferably at most 5 vol %.

In a case where the non-aqueous electrolyte solution of the present invention contains the phosphoric acid ester compound, the content of the phosphoric acid ester compound in the non-aqueous electrolyte solution of the present invention is preferably from 0.01 to 5 vol %, for the same reason as in the case of the non-fluorinated cyclic carbonate compound.

Further, in a case where the non-aqueous electrolyte solution of the present invention contains the phosphoric acid ester compound, N_{P}/N_{Li}i.e. the ratio of the total number of moles (N_{P}) of the phosphoric acid ester compound to the total number of moles (N_{Li}) of lithium atoms derived from the lithium salt, is preferably at least 0.01 and less than 1.0.

Further, the liquid composition in the non-aqueous electrolyte solution of the present invention may contain a fluorinated alkane compound other than the compound (α).

When the liquid composition contains a fluorinated alkane compound, the non-aqueous electrolyte solution will be further excellent in non-flammability (flame retardancy). The fluorinated alkane compound means a compound having at least one hydrogen atom of an alkane substituted by a fluorine atom so that hydrogen atom(s) remain. The fluorinated alkane compound is preferably a C₄₋₁₂ fluorinated alkane compound. When a fluorinated alkane compound having 6 or more carbon atoms is used, the vapor pressure of the non-aqueous electrolyte solution will be low, and with a fluorinated alkane compound having at most 12 carbon atoms, the solubility of a lithium salt will be good. Further, the fluorine content in the fluorinated alkane compound is preferably from 50 to 80 mass %. When the fluorine content in the fluorinated alkane compound is at least 50 mass %, non-flammability (flame retardancy) will be excellent. When the fluorine content in the fluorinated alkane compound is at most 80 mass %, the solubility of a lithium salt can easily be maintained.

The fluorinated alkane compound is preferably a compound of a straight chain structure, and for example, n-C₄F₉CH₂CH₃, n-C₆F₁₃CH₂CH₃, n-C₆F₁₃H or n-C₈F₁₇H may be mentioned. One type of such fluorinated alkane compounds may be used alone, or two or more types may be used in combination.

### [Other Components]

To the non-aqueous electrolyte solution of the present invention, other components may be incorporated as the case requires, in order to improve the functions of the non-aqueous electrolyte solution. Such other components may, for example, be a conventional overcharge-preventing agent, a dehydrating agent, a deoxidizing agent, a property-improving adjuvant to improve cycle properties or capacity-maintaining properties after storage at a high temperature, a surfactant to assist impregnation of the non-aqueous electrolyte solution to the electrode material and the separator, etc.

The overcharge-preventing agent may, for example, be an aromatic compound such as biphenyl, an alkylbiphenyl, terphenyl, partially hydrogenated terphenyl, cyclohexylbenzene, t-butylbenzene, t-amylbenzene, diphenyl ether or dibenzofuran; a partially fluorinated product of the above aromatic compound, such as 2-fluorobiphenyl, o-cyclohexylfluorobenzene or p-cyclohexylfluorobenzene; or a fluorinated anisole compound such as 2,4-difluoroanisole, 2,5-difluoroanisole or 2,6-difluoroanisole. Such overcharge-preventing agents may be used alone or in combination as a mixture of two or more of them.

In a case where the non-aqueous electrolyte solution contains an overcharge-preventing agent, the content of the overcharge-preventing agent in the non-aqueous electrolyte solution is preferably from 0.01 to 5 vol %. By incorporating at least 0.01 vol % of the overcharge-preventing agent in the non-aqueous electrolyte solution, it becomes easier to prevent breakage or ignition of a secondary battery by overcharge, and it is possible to use the secondary battery more stably.

The dehydrating agent may, for example, be molecular sieves, salt cake, magnesium sulfate, calcium hydrate, sodium hydrate, potassium hydrate or lithium aluminum hydrate. As a solvent to be used for the non-aqueous electrolyte solution of the present invention, it is preferred to use one subjected to dehydration by the above dehydrating agent, followed by rectification. Otherwise, a solvent subjected to dehydration by the above dehydrating agent without rectification may be used.

The property-improvement adjuvant to improve the cycle properties or the capacity-maintaining properties after storage at a high temperature, may, for example, be a sulfur-containing compound such as ethylene sulfite, methyl methanesulfonate, busulfan, sulfolene, dimethylsulfone, diphenylsulfone, methylphenylsulfone, dibutyldisulfide, dicyclohexyldisulfide, tetramethylthiuram monosulfide, N,N-dimethylmethane sulfonamide or N,N-diethylmethane sulfonamide; a hydrocarbon compound such as heptane, octane or cycloheptane; or a fluorinated aromatic compound such as fluorobenzene, difluorobenzene or hexafluorobenzene. These property-improving adjuvants may be used alone or in combination as a mixture of two or more of them.

In a case where the non-aqueous electrolyte solution contains a property-improving adjuvant, the content of the property-improving adjuvant in the non-aqueous electrolyte solution is preferably from 0.01 to 5 vol %.

The surfactant may be any one of a cationic surfactant, an anionic surfactant, a non-ionic surfactant and an amphoteric surfactant. From the viewpoint of availability and high surface active effects, an anionic surfactant is preferred. Further, the surfactant is preferably a fluorinated surfactant, since the oxidation resistance is high and the cycle properties and rate properties will be thereby excellent.

As an anionic fluorinated surfactant, the following compounds (5-1) and (5-2) are preferred.

R¹⁴COO^{⊖}M^{1⊕} (5-1)

R¹⁵SO₃^{⊖}M^{2⊕} (5-2)

Here, in the formulae, each of R¹⁴ and R¹⁵ which are independent of each other, is a C₄₋₂₀ perfluoroalkyl group or a C₄₋₂₀ perfluoroalkyl group having an etheric oxygen atom.

Each of M¹ and M² which are independent of each other, is an alkali metal or NH(R¹⁶)₃ (wherein R¹⁶ is a hydrogen atom or a C₁₋₈ alkyl group, provided that the plurality of R¹⁶ may be the same or different).

As R¹⁴ and R¹⁵, a C₄₋₂₀ perfluoroalkyl group or a C₄₋₂₀ perfluoroalkyl group having an etheric oxygen atom is preferred in that the degree for lowering the surface tension of the non-aqueous electrolyte solution is thereby good, and a C₄₋₈ perfluoroalkyl group or a C₄₋₈ perfluoroalkyl group having an etheric oxygen atom is more preferred from the viewpoint of the solubility and environmental burden.

The structure of R¹⁴ and R¹⁵ may be a straight chain structure or a branched structure and may contain a ring structure. From the viewpoint of availability and good surface active effects, the structure of R¹⁴ and R¹⁵ is preferably a straight chain structure.

As the alkali metal for M¹ and M², Li, Na or K is preferred. As M¹ and M², NH₄⁺ is particularly preferred.

Specific example of the compound (5-1) include, for example, fluorinated carboxylic acid salts such as C₄F₉COO⁻NH₄⁺, C₅F₁₁COO⁻NH₄⁺, C₆F₁₃COO⁻NH₄⁺, C₅F₁₁COO⁻NH(CH₃)₃⁺, C₆F₁₃COO⁻NH(CH₃)₃⁺, C₄F₁₃COO⁻Li⁺, C₅F₁₁COO⁻Li⁺, C₆F₁₃COO⁻Li⁺, C₃F₇OCF(CF₃)COO⁻NH₄⁺, C₃F₇OCF(CF₃)CF₂OCF(CF₃)COO⁻NH₄⁺, C₃F₇OCF(CF₃)COO⁻NH(CH₃)₃⁺, C₃F₇OCF(CF₃)CF₂OCF(CF₃)COO⁻NH(CH₃)₃⁺, C₃F₇OCF(CF₃)COO⁻Li⁺, C₂F₅OC₂F₄OCF₂COO⁻Li⁺, C₂F₅OC₂F₄OCF₂COO⁻NH₄⁺, C₃F₇OCF(CF₃)CF₂OCF(CF₃)COO⁻Li⁺, etc.

Among them, from the viewpoint of the solubility in the non-aqueous electrolyte solution and good effects to lower the surface tension, C₅F₁₁COO⁻NH₄⁺, C₅F₁₁COO⁻Li⁺, C₆F₁₃COO⁻Li⁺, C₃F₇OCF(CF₃)COO⁻NH₄⁺, C₃F₇OCF(CF₃)CF₂OCF(CF₃)COO⁻NH₄⁺, C₃F₇OCF(CF₃)COO⁻Li⁺, C₃F₇OCF(CF₃)CF₂OCF(CF₃)COO⁻Li⁺, C₂F₅OC₂F₄OCF₂COO⁻Li⁺ or C₂F₅OC₂F₄OCF₂COO⁻NH₄⁺ is preferred.

Specific examples of the compound (5-2) include, for example, fluorinated sulfonic acid salts such as C₄F₉SO₃⁻NH₄⁺, C₅F₁₁SO₃⁻NH₄⁺, C₆F₁₃SO₃⁻NH₄⁺, C₄F₉SO₃⁻NH(CH₃)₃⁺, C₅F₁₁SO₃⁻NH(CH₃)₃⁺, C₆F₁₃SO₃⁻NH(CH₃)₃⁺, C₄F₉SO₃⁻Li⁺, C₅F₁₁SO₃⁻Li⁺, C₆F₁₃SO₃⁻Li⁺, C₃F₇OCF(CF₃)CF₂OC(CF₃)FSO₃⁻NH₄⁺, C₃F₇OCF(CF₃)CF₂OCF(CF₃)CF₂OCF(CF₃)SO₃⁻NH₄⁺, HCF₂CF₂OCF₂CF₂SO₃⁻NH₄⁺, CF₃CFHCF₂OCF₂CF₂SO₃⁻NH₄⁺, C₃F₇OC(CF₃)FSO₃⁻NH₄⁺, C₃F₇OCF(CF₃)CF₂OC(CF₃)FSO₃⁻NH(CH₃)₃⁺, C₃F₇OCF(CF₃)CF₂OCF(CF₃)CF₂OCF(CF₃)SO₃⁻NH(CH₃)₃⁺, HCF₂CF₂OCF₂CF₂SO⁻NH(CH₃)₃⁺, CF₃CFHCF₂OCF₂CF₂SO₃⁻NH(CH₃)₃⁺, C₃F₇OCF(CF₃)SO₃⁻NH(CH₃)₃⁺, C₃F₇OCF(CF₃)CF₂OC(CF₃)FSO₃⁻Li⁺, C₃F₇OCF(CF₃)CF₂OC(CF₃)FCF₂OCF(CF₃)SO₃⁻Li⁺, HCF₂CF₂OCF₂CF₂SO₃⁻Li⁺, CF₃CFHCF₂OCF₂CF₂SO₃⁻Li⁺, C₃F₇OCF(CF₃)SO₃⁻Li⁺, etc.

Among them, from the viewpoint of the solubility in the non-aqueous electrolyte solution and good effects to lower the surface tension, C₄F₉SO₃⁻NH₄⁺, C₆F₁₃SO₃⁻NH₄⁺, C₄F₉SO₃⁻Li⁺, C₆F₁₃SO₃⁻Li⁺, C₈F₁₇SO₃⁻Li⁺, C₃F₇OCF(CF₃)CF₂OCF(CF₃)SO₃⁻NH₄⁺, C₃F₇OCF(CF₃)CF₂OCF(CF₃)SO₃⁻Li⁺, C₃F₇OCF(CF₃)SO₃⁻NH₄⁺ or C₃F₇OCF(CF₃)SO₃⁻Li⁺ is preferred.

In a case where the liquid composition contains a surfactant, the surfactant to be contained may be one type alone or two or more types in combination.

In a case where the non-aqueous electrolyte solution of the present invention contains a surfactant, the upper limit value for the content of the surfactant in the non-aqueous electrolyte solution is preferably 5 vol %, more preferably 3 vol %, further preferably 2 vol %. Further, the lower limit value is preferably 0.05 vol %.

The lower limit value for the ion conductivity at 25° C. of the non-aqueous electrolyte solution of the present invention is preferably 0.4 S/m. A secondary battery employing an electrolyte solution in which the ion conductivity at 25° C. of the non-aqueous electrolyte solution is less than 0.4 S/m, is poor in the power output properties and in the practical usefulness. When the ion conductivity at 25° C. of the non-aqueous electrolyte solution is at least 0.4 S/m, the secondary battery will be excellent in the power output properties.

### [Preferred Composition of Non-Aqueous Electrolyte Solution]

As the non-aqueous electrolyte solution of the present invention, the following composition 1 is preferred, since it exhibits the desired effects of the present invention.

### (Composition 1)

A non-aqueous electrolyte solution for a secondary battery comprising at least one lithium salt selected from the group consisting of LiPF₆, the compound (A), FSO₂N(Li)SO₂F, CF₃SO₂N(Li)SO₂CF₃, LiClO₄, the compound (B), the compound (C) and LiBF₄; at least one fluorinated ether compound selected from the group consisting of the compounds (1) and (2); the compound (3); and the compound (4).

Further, composition 2 is more preferred.

### (Composition 2)

A non-aqueous electrolyte solution for a secondary battery comprising at least one lithium salt selected from the group consisting of LiPF₆, the compound (A), FSO₂N(Li)SO₂F, LiClO₄ and LiBF₄; at least one member selected from the group consisting of CF₃CH₂OCF₂CHF₂, CF₃CH₂OCF₂CHFCF₃, CHF₂CF₂CH₂OCF₂CHF₂, CH₃CH₂CH₂CH₂OCF₂CHF₂, CH₃CH₂CH₂OCF₂CHF₂, CH₃CH₂OCF₂CHF₂, CHF₂CF₂CH₂OCF₂CHFCF₃, a compound represented by the above formula (2) wherein X is CH₂CH₂ and a compound represented by the above formula (2) wherein X is CH(CH₃)CH₂; at least one member selected from the group consisting of the compounds (3-1) and (3-2); and at least one member selected from the group consisting of 1,3-propane sultone and 2,4-butane sultone.

Further, composition 3 is particularly preferred.

### (Composition 3)

A non-aqueous electrolyte solution for a secondary battery comprising LiPF₆, at least one member selected from the group consisting of CF₃CH₂OCF₂CHF₂, CHF₂CF₂CH₂OCF₂CHF₂ and CHF₂CF₂CH₂OCF₂CHFCF₃, at least one member selected from the group consisting of the compounds (3-1) and (3-2), and at least one member selected from the group consisting of 1,3-propane sultone and 2,4-butane sultone.

The above-described non-aqueous electrolyte solution of the present invention has sufficient ion conductivity, and, as it contains the compound (3) and the compound (4), it has high voltage cycle properties and high voltage high temperature preserving properties. Particularly with respect to the high voltage high temperature preserving properties, by using the fluorinated ether compound, the compound (3) and the compound (4) in the specific ratio, excellent high voltage high temperature preserving properties will be obtainable by their synergistic effects.

Further, the compound (3) and the compound (4) will form a good protective covering on the surface of a graphite negative electrode thereby to prevent decomposition of the non-aqueous electrolyte solution on the graphite negative electrode, and therefore, the non-aqueous electrolyte solution for secondary batteries of the present invention is effective for a lithium ion secondary battery employing a graphite negative electrode.

### <Lithium Ion Secondary Battery>

The lithium ion secondary battery of the present invention is a secondary battery comprising a positive electrode, a negative electrode and the non-aqueous electrolyte solution of the present invention.

### [Positive Electrode]

The positive electrode may be an electrode wherein a positive electrode layer containing a positive electrode active material, a conductivity-imparting agent and a binder, is formed on a current collector.

The positive electrode active material may be any material so long as it is capable of absorbing and desorbing lithium ions, and a positive electrode active material for conventional lithium ion secondary batteries may be employed. For example, a lithium-containing transition metal oxide, a lithium-containing transition metal composite oxide using at least two transition metals, a transition metal oxide, a transition metal sulfide, a metal oxide or an olivine type metal lithium salt may be mentioned.

The lithium-containing transition metal oxide may, for example, be lithium cobalt oxide such as LiCoO₂, lithium nickel oxide such as LiNiO₂ or lithium manganese oxide such as LiMnO₂, LiMn₂O₄, Li₂MnO₃.

As a metal for the lithium-containing transition metal composite oxide, Al, V, Ti, Cr, Mn, Fe, Co, Li, Ni, Cu, Zn, Mg, Ga, Zr, Si or Yb is, for example, preferred. The lithium-containing transition metal composite oxide may, for example, be a lithium ternary composite oxide such as Li(NiₐCO_{b}Mn_{c})O₂ (wherein a, b, c≦0, a+b+c=1) or one having a part of the transition metal atom which mainly constitutes such a lithium transition metal composite oxide substituted by another metal such as Al, Ti, V, Cr, Mn, Fe, Co, Li, Ni, Cu, Zn, Mg, Ga, Zr, Si or Yb. For example, LiMn_{0.5}N_{0.5}O₂, LiMn_{1.8}Al_{0.2}O₄, LiNi_{0.85}Co_{0.10}Al_{0.05}O₂, LiMn_{1.5}Ni_{0.5}O₄, LiNi_{1/3}CO_{1/3}Mn_{1/3}O₂ or LiMn_{1.8}Al_{0.2}O₄ may be mentioned.

The transition metal oxide may, for example, be TiO₂, MnO₂, MoO₃, V₂O₅, V₆O₁₃. The transition metal sulfide may, for example, be TiS₂, FeS or MoS₂. The metal oxide may, for example, be SnO₂ or SiO₂.

The olivine type metal lithium salt is a substance represented by the formula Li_{L}XₓY_{y} O_{z}F_{g} (wherein X is Fe(II), Co(II), Mn(II), Ni(II), V(II) or Cu(II), Y is P or Si, and L, x, y, z and g are, respectively, 0≦L≦3, 1≦x≦2, 1≦y≦3, 4≦z≦12 and 0≦g≦1) or a composite thereof. For example, LiFePO₄, Li₃Fe₂ (PO₄)₃, LiFeP₂O₇, LiMnPO₄, LiNiPO₄, LiCoPO₄, Li₂FePO₄F, Li₂MnPO₄F, Li₂NiPO₄F, Li₂CoPO₄F, Li₂FeSiO₄, Li₂MnSiO₄, Li₂NiSiO₄ or Li₂CoSiO₄ may be mentioned.

These positive electrode active materials may be used alone or in combination as a mixture of two or more of them.

Further, such a positive electrode active material having on its surface an attached substance having a composition different from the substance constituting the positive electrode active material as the main component may also be used. The surface-attached substance may, for example, be an oxide such as aluminum oxide, silicon oxide, titanium oxide, zirconium oxide, magnesium oxide, calcium oxide, boron oxide, antimony oxide or bismuth oxide; a sulfate such as lithium sulfate, sodium sulfate, potassium sulfate, magnesium sulfate, calcium sulfate or aluminum sulfate; or a carbonate such as lithium carbonate, calcium carbonate or magnesium carbonate.

With regard to the amount of the surface-attached substance, the lower limit of the mass to the positive electrode active material is preferably 0.1 mass ppm, more preferably 1 mass ppm, further preferably 10 mass ppm. The upper limit is preferably 20 mass %, more preferably 10 mass %, further preferably 5 mass %. By the surface-attached substance, it is possible to suppress an oxidation reaction of the non-aqueous electrolyte solution at the surface of the positive electrode active material and thereby to improve the battery life.

The positive electrode active material is preferably a lithium-containing transition metal oxide having an α-NaCrO₂ structure as matrix, such as LiCoO₂, LiNiO₂ or LiMnO₂, or a lithium-containing transition metal oxide having a spinel structure as matrix, such as LiMn₂O₄, since its discharge voltage is high and its electrochemical stability is high.

The conductivity-imparting agent may, for example, be a metal material such as Al or a powder of a conductive oxide, in addition to a carbon material.

The binder may, for example, be a resin binder such as polyvinylidene fluoride, or a rubber binder such as hydrocarbon rubber or fluorinated rubber.

The current collector may be a thin metal film composed mainly of e.g. Al.

### [Negative Electrode]

The negative electrode may be an electrode wherein a negative electrode layer containing a negative electrode active material, a conductivity-imparting agent and a binder, is formed on a current collector.

The negative electrode active material may be at least one member selected from the group consisting of lithium metal, a lithium alloy and a carbon material capable of absorbing and desorbing lithium ions.

The carbon material may, for example, be graphite, coke or hard carbon.

The lithium alloy may, for example, be a Li—Si alloy, a Li—Al alloy, a Li—Pb alloy or a Li—Sn alloy.

As the binder and conductivity-imparting agent for the negative electrode, ones equal to those for the positive electrode may be used.

Further, in a case where the negative electrode active material can maintain the shape by itself (e.g. a thin lithium metal film), the negative electrode may be formed solely of the negative electrode active material.

Between the positive electrode and the negative electrode, a separator is usually interposed in order to prevent short circuiting. Such a separator may, for example, be a porous film. In such a case, the non-aqueous electrolyte solution is used as impregnated to the porous film. Further, such a porous film having the non-aqueous electrolyte solution impregnated and gelated, may be used as a gel electrolyte.

As the porous film, one which is stable against the non-aqueous electrolyte solution and is excellent in the liquid-maintaining property, may be used. Preferred is a porous sheet or a non-woven fabric made of a fluororesin such as polyvinylidene fluoride, polytetrafluoroethylene or a copolymer of ethylene and tetrafluoroethylene, a polyimide, or a polyolefin such as polyethylene or polypropylene. The material for the porous film is more preferably a polyolefin such as polyethylene or polypropylene. Further, such materials may be laminated to have a two-layered or three-layered structure.

On the surface of the separator and/or the electrode, a fine inorganic particle layer may be provided in order to improve the heat resistance or shape-maintaining property. As such fine inorganic particles, silica, alumina, titania, magnesia, etc. may, for example, be mentioned.

The material for a battery exterior package to be used for the lithium ion secondary battery of the present invention may, for example, be nickel-plated iron, stainless steel, aluminum or its alloy, nickel, titanium, a resin material, or a film material.

The shape of the secondary battery may be selected depending upon the particular application, and it may be a coin-form, a cylindrical form, a square form or a laminate form. Further, the shapes of the positive electrode and the negative electrode may also be suitably selected to meet with the shape of the secondary battery.

The charging voltage of the secondary battery of the present invention is preferably at least 4.25 V, more preferably at least 4.30 V, further preferably at least 4.35 V, particularly preferably at least 4.40 V.

The secondary battery of the present invention as described above, employs the non-aqueous electrolyte solution of the present invention, whereby it has sufficient ion conductivity and further has excellent high voltage cycle properties and high voltage high temperature preserving properties. Thus, the secondary battery of the present invention may be used in various applications to e.g. mobile phones, portable game devices, digital cameras, digital video cameras, electric tools, notebook computers, portable information terminals, portable music players, electric vehicles, hybrid cars, electric trains, aircrafts, satellites, submarines, ships, uninterruptible power supply systems, robots and electric power storage systems. Further, the secondary battery of the present invention is particularly effective as a large size secondary battery for e.g. electric vehicles, hybrid cars, electric trains, aircrafts, satellites, submarines, ships, uninterruptible power supply systems, robots and electric power storage systems.

### EXAMPLES

Now, the present invention will be described in detail with reference to Examples. However, it should be understood that the present invention is by no means restricted by the following description. Ex. 1 to 23 are Preparation Examples, Ex. 24 to 33, 44 to 47 and 49 to 52 are Examples of the present invention, and Ex. 34 to 43, 48 and 53 are Comparative Examples.

### Preparation of Non-Aqueous Electrolyte Solution

### Ex. 1

A liquid composition comprising 43 vol % of fluoroethylene carbonate (compound (3), FEC), 32 vol % of 1,3-propane sultone (PS) and 25 vol % of CF₃CH₂O—CF₂CHF₂ (HFE 1), was prepared, and LiPF₆ was dissolved in the liquid composition so that its concentration became 1 M, to obtain a non-aqueous electrolyte solution 1.

### Ex. 2 to 23

Non-aqueous electrolyte solutions 2 to 23 were prepared in the same manner as in Ex. 1 except that the composition of the liquid composition was changed as shown in Table 1.

TABLE 1
Unit: vol %

| | Non- | | | | | | | | | |
|---|---|---|---|---|---|---|---|---|---|---|
| | aqueous | | | | | | | | | |
| | electrolyte | | | | | | | | | |
| | solution | HFE 1 | HFE 2 | HFE 3 | FEC | PS | EC | EMC | DMC | DOC |
| Ex. 1 | 1 | 25 | — | — | 43 | 32 | — | — | — | — |
| Ex. 2 | 2 | 27 | — | — | 57 | 16 | — | — | — | — |
| Ex. 3 | 3 | 31 | — | — | 57 | 12 | — | — | — | — |
| Ex. 4 | 4 | 16 | — | — | 43 | 32 | — | — | 9 | — |
| Ex. 5 | 5 | 15 | — | | 57 | 16 | — | — | — | 12 |
| Ex. 6 | 6 | 18 | — | — | 57 | 16 | — | — | 9 | — |
| Ex. 7 | 7 | 18 | — | — | 57 | 8 | — | — | 17 | — |
| Ex. 8 | 8 | — | 31 | — | 57 | 12 | — | — | — | — |
| Ex. 9 | 9 | — | — | 25 | 43 | 32 | — | — | — | — |
| Ex. 10 | 10 | — | — | 27 | 57 | 16 | — | — | — | — |
| Ex. 11 | 11 | — | — | 19 | 58 | 17 | — | — | 6 | — |
| Ex. 12 | 12 | — | — | 18 | 57 | 8 | — | — | 17 | — |
| Ex. 13 | 13 | — | — | | 2 | — | 49 | 49 | — | — |
| Ex. 14 | 14 | 31 | — | — | 2 | 8 | 19 | 40 | — | — |
| Ex. 15 | 15 | 33 | — | — | 7 | — | 19 | 41 | — | — |
| Ex. 16 | 16 | — | — | — | 2 | 12 | 27 | 59 | — | — |
| Ex. 17 | 17 | — | — | — | 11 | — | 28 | 61 | — | — |
| Ex. 18 | 18 | — | 40 | — | 60 | — | — | — | — | — |
| Ex. 19 | 19 | — | — | — | 43 | 32 | — | — | 25 | — |
| Ex. 20 | 20 | — | — | — | 57 | 16 | — | — | 27 | — |
| Ex. 21 | 21 | — | — | 40 | 60 | — | — | — | — | — |
| Ex. 22 | 22 | — | — | 31 | 2 | 8 | 19 | 40 | — | — |
| Ex. 23 | 23 | — | — | 17 | 43 | 40 | — | — | — | — |

Here, abbreviations in Table 1 have the following meanings.

FEC: fluoroethylene carbonate

PS: 1,3-propane sultone

EC: ethylene carbonate

EMC: ethylmethyl carbonate

DMC: dimethyl carbonate

DEC: diethyl carbonate

HFE 1: CF₃CH₂OCF₂CHF₂

HFE 2: CHF₂CF₂CH₂OCF₂CHF₂

HFE 3: CHF₂CF₂CH₂OCF₂CHFCF₃

### Ex. 24

32.0 g of LiNi_{0.5}Co_{0.2}MnO_{0.3}O₂ (trade name: “Selion L5401”, manufactured by AGC Seimi Chemical Co., Ltd.) as a positive electrode active material, 0.8 g of acetylene black as a conductivity-imparting material and 6.66 g of N-methyl-pyrrolidone (NMP) having 12 mass % of polyvinylidene fluoride (PVdF) as a binder dissolved therein, were added to 10.68 g of a diluting NMP solvent, followed by mixing to obtain a slurry. The obtained slurry was applied to an aluminum foil having a thickness of 20 μm and dried, followed by pressing and punching out in a circle having a diameter of 18 mm to obtain a positive electrode. Further, 4.25 g of artificial graphite as a negative electrode active material, 0.125 g of an aqueous dispersion containing 40 mass % of styrene butadiene rubber as a binder, 0.15 g of acetylene black and 8.52 g of a 1 mass % carboxymethyl cellulose aqueous solution, were mixed to obtain a slurry. The obtained slurry was applied to a copper foil having a thickness of 20 μm and dried, followed by pressing and punching out in a circle having a diameter of 19 mm to obtain a negative electrode. As a separator, a polyolefin type finely porous film was disposed between the above positive electrode and the above negative electrode, and 0.5 mL of the non-aqueous electrolyte solution 1 prepared in Ex. 1 was added thereto to prepare a cell 1 for evaluation.

### Ex. 25 to 43

Cells 2 to 20 for evaluation were prepared in the same manner as in Ex. 24 except that instead of the non-aqueous electrolyte solution 1, non-aqueous electrolyte solutions shown in Tables 2 to 4 were used.

### [Evaluation of High Voltage Cycle Properties]

Each of the cells 1 to 6 and 11 to 19 for evaluation was set in a constant temperature vessel maintained at 25° C. and connected to a charge and discharge apparatus.

In cycle 1, constant current charging to 3.4 V (cell voltage, the same applies hereinafter) was carried out at a current (0.02 C) where the theoretical capacity of the positive electrode can be discharged in 50 hours, then constant current charging to 4.5 V was carried out at a current (0.2 C) where such discharge can be done in 5 hours, and constant voltage charging was carried out until the charging current reached a current value of 0.02 C. After a recess for 10 minutes, constant current discharging to 3 V was carried out at a current value of 0.2 C.

In cycle 2, after a recess for 10 minutes, constant current charging to 4.5 V was carried out at 0.2 C, then constant voltage charging was carried out until the charging current reached a current value of 0.02 C, and after a recess for 10 minutes, constant current discharging to 3 V was carried out at a current value of 0.2 C. Cycles 3 to 50 were carried out in the same manner as cycle 2.

In the above charging/discharging cycle test, the ratio of the discharge capacity in cycle 50 to the discharge capacity in cycle 1 was taken as the discharge capacity-retention ratio, and the high voltage cycle properties were thereby evaluated. The results are shown in Table 2.

### [Evaluation of High Voltage High Temperature Preserving Properties]

Each of the cells 5, 7 to 9, 11, 14 to 16 and 20 for evaluation was set in a constant temperature vessel maintained at 25° C. and connected to a charge and discharge apparatus.

In cycle 1, constant current charging to a cell voltage of 4.2 V at a current of 0.2 C, and after reaching 4.2 V, constant voltage charging was carried out until the charging current was lowered to 0.02 C. After a recess for 10 minutes, constant current discharging to 3.0 V was carried out at a current of 0.2 C.

In cycle 2, after a recess for 10 minutes, constant current charging to 4.2 V was carried out at a current of 0.2 C, and after reaching 4.3 V, constant voltage charging was carried out until the charging current was lowered to 0.02 C. After a recess for 10 minutes, constant current discharging to 3.0 V was carried out at a current value of 0.2 C, and further, constant voltage discharging was carried out at a constant voltage of 3.0 V until the discharge current was lowered to 0.02 C.

After transferring the cells for evaluation to a constant temperature vessel maintained at 60° C., cycles 3 to 5 were carried out. In cycle 3, constant current charging to 4.5 V was carried out at 0.1 C, and after reaching 4.5 V, constant voltage charging was carried out until the charging current was lowered to 0.01 C. After a recess for 10 minutes, constant current discharging to 3.0 V was carried out at a current of 0.2 C.

In cycle 4, after a recess for 10 minutes, constant current charging to 4.5 V was carried out at a current of 0.1 C, further, constant voltage charging was carried out at a constant voltage of 4.5 V until 120 hours passed, and then, after a recess for 10 minutes, constant current discharging to 3.0 V was carried out at a current of 0.2 C.

In cycle 5, constant current charging to 4.5 V was carried out at a current of 0.1 C, and after reaching 4.5 V, constant voltage charging was carried out until the charging current was lowered to 0.01 C. After a recess for 10 minutes, constant current discharging to 3.0 V was carried out at a current of 0.2 C.

In the above high temperature preserving test, the ratio of the discharge capacity in cycle 4 to the discharge capacity in cycle 3 was taken as the discharge capacity-retention ratio, and the ratio of the discharge capacity in cycle 5 to the discharge capacity in cycle 3 was taken as the discharge capacity recovery ratio. The high voltage high temperature preserving properties were thereby evaluated. The results are shown in Table 3.

### [Evaluation of High Rate High Voltage Cycle Properties]

Each of the cells 10 to 12 and 14 for evaluation was set in a constant temperature vessel maintained at 25° C. and connected to a charge and discharge apparatus.

In cycle 1, constant current charging to 3.4 V (cell voltage, the same applies hereinafter) was carried out at a current (0.02 C) where the theoretical capacity of the positive electrode can be discharged in 50 hours, then constant current charging to 4.5 V was carried out at a current (0.2 C) where such discharge can be done in 5 hours, and constant voltage charging was carried out until the charging current reached a current value of 0.02 C. After a recess for 10 minutes, constant current discharging to 3 V was carried out at a current value of 0.2 C.

In cycles 2 to 5, after a recess for 10 minutes, constant current charging to 4.5 V was carried out at 0.2 C, then constant voltage charging was carried out until the charging current reached a current value of 0.02 C, and after a recess for 10 minutes, constant current discharging to 3 V was carried out at a current value of 0.2 C.

In cycle 6, after a recess for 10 minutes, constant current charging to 4.5 V was carried out at a current (1.0 C) where discharge can be done in one hour, and constant voltage charging was carried out until the charging current reached a current value of 0.02 C. After a recess for 10 minutes, constant current discharging to 3V was carried out at a current value of 1.0 C.

Cycles 7 to 300 were carried out in the same manner as cycle 6.

In the above charging/discharging cycle test, the ratio of the discharge capacity in cycle 300 to the discharge capacity in cycle 7 was taken as the discharge capacity-retention ratio, and the high rate high voltage cycle properties were thereby evaluated. The results are shown in Table 4.

### Ex. 44 to 48

### Evaluation of Ion Conductivity

Measurement of ion conductivity was carried out with respect to the non-aqueous electrolyte solutions 1, 3, 4, 9 and 23. The results are shown in Table 5.

### Ex. 49 to 52

Using a positive electrode prepared in the same manner as in Ex. 24 except that LiCoO₂ (trade name: “Selion C-390”, manufactured by AGC Seimi Chemical Co., Ltd.) was used as a positive electrode active material, and the same negative electrode and separator as in Ex. 24, 0.5 mL of each of the non-aqueous electrolyte solutions 2, 3, 7 and 8 prepared in Ex. 2, 3, 7 and 8 was added thereto, to prepare cells 21 to 24 for evaluation.

### Ex. 53

A cell 25 for evaluation was prepared in the same manner as in Ex. 49 to 52 except that the non-aqueous electrolyte solution 13 was used instead of said non-aqueous electrolyte solutions.

### [Evaluation of High Rate High Voltage Cycle Properties]

Using the cells 21 to 25 for evaluation, the high rate high voltage cycle properties were evaluated under the same conditions as in Ex. 33.

In the above charging/discharging cycle test, the ratio of the discharge capacity in cycle 70 to the discharge capacity in cycle 7 was taken as the discharge capacity-retention ratio, and the high rate high voltage cycle properties were thereby evaluated. The results are shown in Table 6.

TABLE 2

| | | Non-aqueous | |
|---|---|---|---|
| | Cell for | electrolyte | Discharge capacity |
| | evaluation | solution | retention ratio (%) |
| Ex. 24 | 1 | 1 | 87.8 |
| Ex. 25 | 2 | 2 | 89.1 |
| Ex. 26 | 3 | 4 | 88.1 |
| Ex. 27 | 4 | 5 | 87.5 |
| Ex. 28 | 5 | 6 | 89.4 |
| Ex. 29 | 6 | 7 | 87.5 |
| Ex. 34 | 11 | 13 | 85.1 |
| Ex. 35 | 12 | 14 | 87.0 |
| Ex. 36 | 13 | 15 | 80.4 |
| Ex. 37 | 14 | 16 | 84.4 |
| Ex. 38 | 15 | 17 | 85.0 |
| Ex. 39 | 16 | 18 | 87.5 |
| Ex. 40 | 17 | 19 | Terminated |
| Ex. 41 | 18 | 20 | Terminated |
| Ex. 42 | 19 | 21 | 85.7 |

TABLE 3

| | | | Discharge | Discharge |
|---|---|---|---|---|
| | | Non-aqueous | capacity | capacity |
| | | electrolyte | retention ratio | recovery ratio |
| | Cell evaluation | solution | (%) | (%) |
| Ex. 28 | 5 | 6 | 91.8 | 90.0 |
| Ex. 30 | 7 | 9 | 91.7 | 90.5 |
| Ex. 31 | 8 | 10 | 93.5 | 89.1 |
| Ex. 32 | 9 | 11 | 91.1 | 89.5 |
| Ex. 34 | 11 | 13 | 84.5 | 82.1 |
| Ex. 37 | 14 | 16 | 91.4 | 89.4 |
| Ex. 38 | 15 | 17 | 84.1 | 81.8 |
| Ex. 39 | 16 | 18 | 80.0 | 76.8 |
| Ex. 43 | 20 | 22 | 86.9 | 84.9 |

TABLE 4

| | | | Discharge |
|---|---|---|---|
| | | Non-aqueous | capacity |
| | | electrolyte | retention ratio |
| | Cell evaluation | solution | (%) |
| Ex. 33 | 10 | 12 | 68.5 |
| Ex. 34 | 11 | 13 | 42.5 |
| Ex. 35 | 12 | 14 | 11.9 |
| Ex. 37 | 14 | 16 | 7.5 |

TABLE 5

| | Non-aqueous | Conductivity |
|---|---|---|
| | electrolyte solution | S/m |
| Ex. 44 | 1 | 0.493 |
| Ex. 45 | 3 | 0.560 |
| Ex. 46 | 4 | 0.536 |
| Ex. 47 | 9 | 0.498 |
| Ex. 48 | 23 | 0.399 |

TABLE 6

| | | | Discharge |
|---|---|---|---|
| | | Non-aqueous | capacity |
| | | electrolyte | retention ratio |
| | Cell evaluation | solution | (%) |
| Ex. 49 | 21 | 2 | 91.3 |
| Ex. 50 | 22 | 3 | 93.9 |
| Ex. 51 | 23 | 7 | 87.3 |
| Ex. 52 | 24 | 8 | 92.0 |
| Ex. 53 | 25 | 13 | 54.4 |

As shown in Table 2, in Ex. 24 to 29 wherein the non-aqueous electrolyte solutions of the present invention were used, the discharge capacity-retention ratio was high in the charging/discharging cycle test, and the high voltage cycle properties were excellent, as compared with Ex. 34 to 42 wherein at least one of a fluorinated ether compound, a fluorinated cyclic carbonate compound and a sultone compound was not contained, or the content thereof was deficient.

Further, as shown in Table 3, in Ex. 28 and 30 to 32 wherein the non-aqueous electrolyte solutions of the present invention were used, both the discharge capacity-retention ratio and the discharge capacity recovery ratio were high in the high temperature preserving test, and the high voltage high temperature preserving properties were excellent, as compared with Ex. 34, 37 to 39 and 42 wherein at least one of a fluorinated ether compound, a fluorinated cyclic carbonate compound and a sultone compound was not contained, or the content thereof was deficient. When Ex. 34 and Ex. 37 are compared, it is seen that the discharge capacity retention ratio and the discharge capacity recovery ratio in the high temperature preserving test were improved by about 7% by the addition of the sultone compound in the non-aqueous electrolyte solution containing no fluorinated ether compound.

Whereas, when Ex. 39 and 42 and Ex. 28 and 30 are compared, it is seen that both the discharge retention ratio and the discharge capacity recovery ratio were improved by the addition of the sultone compound in the non-aqueous electrolyte solution comprising the fluorinated ether compound and the fluorinated cyclic carbonate compound in the specific ratio, and an effect to remarkably improve the high voltage high temperature preserving properties was thus obtained. This is considered attributable to a synergistic effect of the fluorinated ether compound, the fluorinated cyclic carbonate compound and the sultone compound.

Further, as shown in Table 4, in Ex. 33 wherein the non-aqueous electrolyte solution of the present invention was used, the discharge capacity-retention ratio was high in the high rate charging/discharging cycle test, and the high rate high voltage cycle properties were excellent, as compared with Ex. 34, 35 and 37 wherein at least one of a fluorinated ether compound, a fluorinated cyclic carbonate compound and a sultone compound was not contained, or the content thereof was deficient.

Further, as shown in Table 6, even in a case where lithium cobaltate was used as a positive electrode active material, in Ex. 49 to 52 wherein the non-aqueous electrolyte solutions of the present invention were used, the discharge capacity-retention ratio was high in the high rate charging/discharging cycle test, and the high rate high voltage cycle properties were excellent, as compared with Ex. 53 wherein a fluorinated ether compound and a sultone compound were not contained, and the content of the fluorinated cyclic carbonate compound was deficient.

Further, as shown in Table 2, in Ex. 40 and Ex. 41 employing a non-aqueous electrolyte solution which contained no fluorinated ether compound and had the amount of the chain carbonate compound increased, it became difficult to conduct a charging/discharging current at the initial stage in the charging/discharging cycle test, and it was not possible to complete the test. After the termination, the cells 17 and 18 for evaluation were disassembled, whereby the electrolyte solutions were observed as repelled by or not impregnated to the polyolefin type separator, and it is considered that such poor wettability of the non-aqueous electrolyte solutions 19 and 20 was a cause for the charging/discharging failure.

Further, in Ex. 37 wherein the sultone compound was contained, but no fluorinated ether compound was contained, and the fluorinated cyclic carbonate compound was deficient, the high voltage cycle properties were inadequate, although excellent high voltage high temperature preserving properties were obtained by the effect of the sultone compound.

Further, in Ex. 39 wherein the fluorinated ether compound and the fluorinated cyclic carbonate compound were contained, but no sultone compound was contained, the high voltage high temperature preserving properties were inadequate, although excellent high voltage cycle properties were obtained.

Further, as shown in Table 5, in Ex. 44 to 47 wherein the non-aqueous electrolyte solutions of the present invention were used, the ion conductivity exceeded 0.40 S/m in all of them, thus exhibiting practically adequate performance, whereas in Ex. 48, wherein the non-aqueous electrolyte solution containing propane sultone excessively was used, the ion conductivity was less than 0.4 S/m, thus not exhibiting practically adequate performance.

### INDUSTRIAL APPLICABILITY

The non-aqueous electrolyte solution for secondary batteries of the present invention is useful for the production of a lithium ion secondary battery which is excellent in the high voltage cycle properties and high voltage high temperature preserving properties.

This application is a continuation of PCT Application No. PCT/JP2013/065725, filed on Jun. 6, 2013, which is based upon and claims the benefit of priority from Japanese Patent Application No. 2012-128985 filed on Jun. 6, 2012. The contents of those applications are incorporated herein by reference in their entireties.

What is claimed is:

1. A non-aqueous electrolyte solution for secondary batteries, comprising a lithium salt and a liquid composition, wherein
the liquid composition comprises from 5 to 50 vol % of at least one fluorinated ether compound selected from the group consisting of a compound represented by the following formula (1) and a compound represented by the following formula (2), from 5 to 70 vol % of a fluorinated cyclic carbonate compound represented by the following formula (3), and from 1 to 35 vol % of a sultone compound represented by the following formula (4): 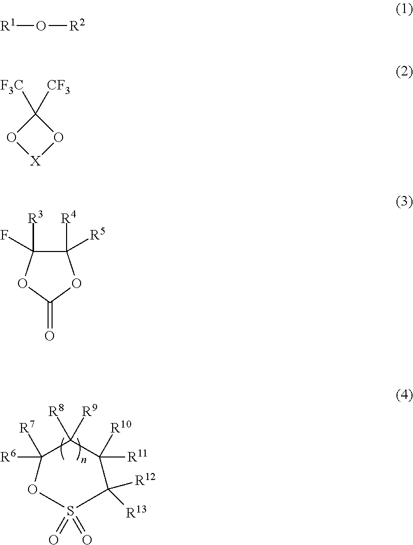
wherein each of R¹ and R² which are independent of each other, is a C₁₋₁₀ alkyl group, a C₃₋₁₀ cycloalkyl group, a C₁₋₁₀ fluorinated alkyl group, a C₃₋₁₀ fluorinated cycloalkyl group, a C₂₋₁₀ alkyl group having an etheric oxygen atom, or a C₂₋₁₀ fluorinated alkyl group having an etheric oxygen atom, provided that one or each of R¹ and R² is a C₁₋₁₀ fluorinated alkyl group, a C₃₋₁₀ fluorinated cycloalkyl group, or a C₂₋₁₀ fluorinated alkyl group having an etheric oxygen atom;
X is a C₁₋₅ alkylene group, a C₁₋₅ fluorinated alkylene group, a C₂₋₅ alkylene group having an etheric oxygen atom, or a C₂₋₅ fluorinated alkylene group having an etheric oxygen atom;
each of R³ to R⁵ which are independent of one another, is a C₁₋₄ alkyl group, a fluorine atom, or a hydrogen atom;
each of R⁶ to R¹³ which are independent of one another, is a hydrogen atom, a fluorine atom, or a methyl group; and
n is 0 or 1.

2. The non-aqueous electrolyte solution for secondary batteries according to claim 1, wherein the fluorinated cyclic carbonate compound is a compound represented by the formula (3) wherein each of R³ and R⁵ is a hydrogen atom, and R⁴ is a hydrogen atom or a fluorine atom.

3. The non-aqueous electrolyte solution for secondary batteries according to claim 1, wherein the sultone compound is a compound represented by the formula (4) wherein each of R⁶ to R¹² is a hydrogen atom, and R¹³ is a hydrogen atom or a methyl group.

4. The non-aqueous electrolyte solution for secondary batteries according to claim 1, wherein the fluorinated ether compound is a compound represented by the formula (1), and said compound is at least one member selected from the group consisting of CF₃CH₂OCF₂CHF₂, CF₃CH₂OCF₂CHFCF₃, CHF₂CF₂CH₂OCF₂CHF₂, CH₃CH₂CH₂CH₂OCF₂CHF₂, CH₃CH₂CH₂OCF₂CHF₂, CH₃CH₂OCF₂CHF₂ and CHF₂CF₂CH₂OCF₂CHFCF₃.

5. The non-aqueous electrolyte solution for secondary batteries according to claim 1, wherein the liquid composition further contains at least one member selected from the group consisting of a cyclic carbonate compound having no fluorine atom, a chain carbonate compound, a saturated cyclic sulfone compound and a phosphoric acid ester compound.

6. The non-aqueous electrolyte solution for secondary batteries according to claim 1, wherein the ion conductivity at 25° C. of the non-aqueous electrolyte solution is at least 0.4 S/m.

7. The non-aqueous electrolyte solution for secondary batteries according to claim 1, wherein the lithium salt contains LiPF₆.

8. The non-aqueous electrolyte solution for secondary batteries according to claim 1, wherein the content of the lithium salt in the non-aqueous electrolyte solution is from 0.1 to 3.0 mol/L.

9. A lithium ion secondary battery comprising a positive electrode containing, as an active material, a material capable of absorbing and desorbing lithium ions, a negative electrode containing, as an active material, at least one member selected from the group consisting of metal lithium, an lithium alloy and a carbon material capable of absorbing and desorbing lithium ions, and the non-aqueous electrolyte solution for secondary batteries as defined in claim 1.
